(19) United States
(12) Patent Application Publication
(10) Pub. No.: US 2024/0095524 A1
(43) Pub. Date: Mar. 21, 2024

(54) SYSTEM AND METHOD FOR THE AUTOMATED LEARNING OF LEAN CNN NETWORK ARCHITECTURES

(71) Applicant: CARNEGIE MELLON UNIVERSITY, Pittsburgh, PA (US)

(72) Inventors: Marios Savvides, Pittsburgh, PA (US); Uzair Ahmed, Pittsburgh, PA (US); Thanh Hai Phan, Pittsburgh, PA (US)

(21) Appl. No.: 18/275,320

(22) PCT Filed: Feb. 16, 2022
(86) PCT No.: PCT/US2022/016517

§ 371 Date: Aug. 1, 2023

Related U.S. Application Data
(60) Provisional application No. 63/150,133, filed on Feb. 17, 2021.

(51) Int. Cl. G06N 3/08

(52) U.S. Cl. CPC G06N 3/08

(57) ABSTRACT

Disclosed herein is a system and method for evolving a deep neural network model by searching for hidden sub-networks within the model. The model is evolved by adding convolutional layers to the model, then pruning the model to remove redundant filters. The model is exposed to training samples of increasing complexity each time the model is evolved, until a desired level of performance is achieved, at which time, the model is exposed to all available training data.

### RELATED APPLICATIONS

This application claims the benefit of U.S. Provisional Patent Application No. 63/150,133, filed Feb. 17, 2021, the contents of which are incorporated herein in their entirety.

### BACKGROUND

Manually designing deep neural networks in a trial-and-error, ad hoc fashion is a tedious process requiring both architectural engineering skills and domain expertise. Experts in the design of such networks rely on past experience and technical knowledge to create and design a neural network. Designing novel neural network architectures involves searching over a huge space of hyperparameters concerning the number of layers in the network, the number of filters in each layer, different initializations, normalization techniques etc. Manually creating different configurations of the network architecture spanning different settings under each of the mentioned parameters makes creating novel architectures is difficult and inefficient.

Neural architecture search (NAS) is a technique for automating the design of neural networks to alleviate or reduce the effort required by the network architect and to optimize the network topology to achieve the best performance for a particular (engagement task. In some cases, NAS may automate the entire parameter search process by automatically cycling through different parameter settings and evaluating the performance of the network after training.

### SUMMARY

Deep neural networks support the lottery hypothesis, which postulates that there are different sub-networks within the network which are more efficient for particular classification tasks than the whole network. Disclosed herein is a system and method for searching for the hidden sub-networks within the deep neural network. The network is evolved by iteratively adding layers and pruning until the desired performance is achieved. To find the sub-networks, in some embodiments, a structured L1 pruning strategy is used, where filters with low L1 norms are dropped from the network, thus reducing the parameters resulting in the evolution of a lean and efficient CNN architecture.

The disclosed method imposes further constraints on the model weights to prune away inefficient weights while the model is growing in its constructive elements. The method provides the user with efficient networks that leverage the lottery ticket hypothesis, thus leading to the construction of a lean model architecture which can be used on low power devices.

### BRIEF DESCRIPTION OF THE DRAWINGS

By way of example, a specific exemplary embodiment of the disclosed system and method will now be described, with reference to the accompanying drawings, in which:

FIG. 1 is a flow diagram depicting the steps in the method.

### DETAILED DESCRIPTION

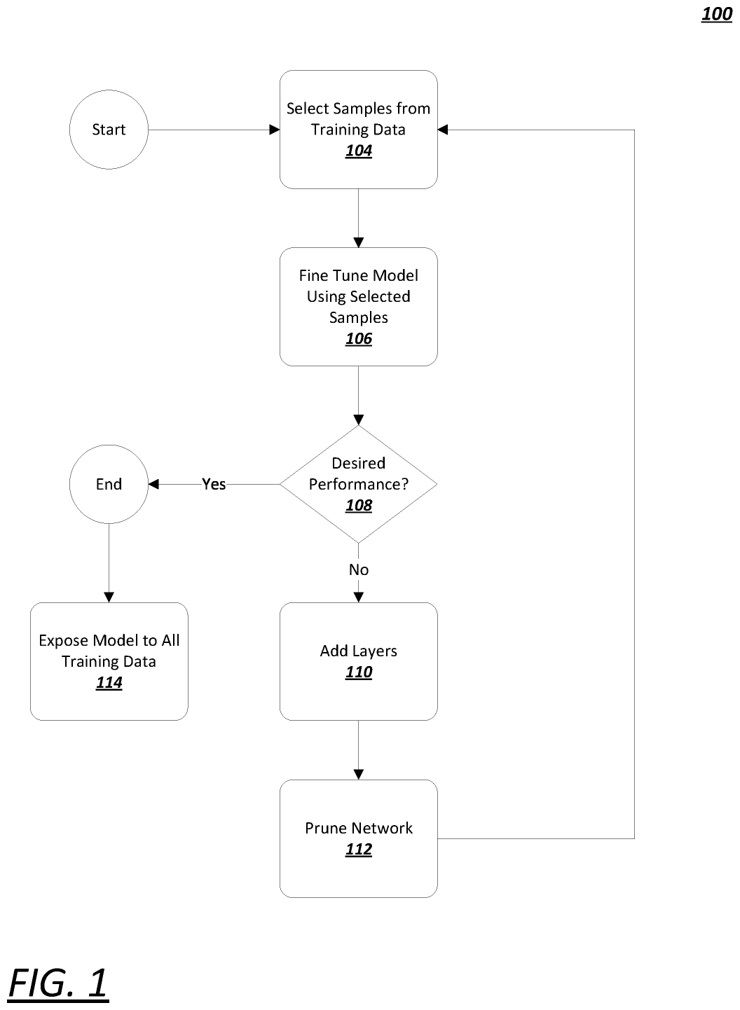

FIG. 1 is a flowchart depicting steps comprising a method implementing one embodiment of the invention. When the method starts, at step 104, samples are selected from the training data. In a preferred embodiment, the samples initially selected will be “easy” samples for the model to classify, for example, samples having nicely clustered features may initially be selected. At step 106 of the process, the model is fine-tuned using the selected samples. The performance of the model is then tested at step 108. If the model is exhibiting the desired performance, the process ends.

The performance of the model can be measured using a metric indicating, for example, the percentage of objects in the training dataset that the model is able to correctly classify. If the metric measuring the performance of the model exceeds a certain per briefing avoid the one in FIG. 1. Centage, the model may be deemed to have acceptable performance. In alternate embodiments of the method, the metric may measure the FLOPs of the model used for each classification task and, if the FLOPs exceed a predetermined threshold, the iteration of the method is terminated.

If, by measurement of the metric, the performance of the model is below the acceptable threshold, the model is enhanced by adding one or more layers at step 110. In a preferred embodiment, layers may be added one at a time for each iteration of the steps of the method until the desired performance is achieved. In other embodiments, more than one layer at a time may be added. In one embodiment, the additional layers are initialized with random weights. In alternate embodiments, the additional layers may be initialized by some other method, for example, using pre-trained weights from other models.

At step 112 of the method, the weights in all layers of the model are pruned to remove inefficient weights. In one embodiment of the invention, L1 pruning is used. In this embodiment, a filter is pruned if the L1 norm of its response (i.e., activation) is in the bottom segment, as defined by a hyperparameter. The hyperparameter is referred to as a pruning factor that can be set between 1 (no pruning) and 0 (complete pruning). For example, a pruning factor of 0.8 means that the top 80% of the filters are kept (i.e., the top segment), while the bottom 20% of filters are removed (i.e., the bottom segment). This effectively only keeps filters that, on average, provide high enough activation responses. The pruning factor can be understood as the factor or percent of parameters to keep while pruning or permanently deactivating the rest. In other embodiments, other methods of pruning may be used.

The method then returns to step 104, where additional samples are selected from the training dataset. During the model evolution, while the model complexity is low, the model is trained based on a strategy derived from curriculum learning. Data is sampled to select features of data points with higher norm values as high norm values are, on average, easier samples for the model to classify. As the complexity of the model increases with each iteration, wherein additional layers are added to the model's architecture, the difficulty of the classification task is increased by adding samples with slightly lower norms. This ensures that the complexity of the training data is always under check and on par with the complexity of the model during as it evolves.

Fine-tuning again occurs at step 106 with the newly-added samples from the training dataset, and the model is again evaluated at step 108 to determine if the desired performance has been achieved. The loop depicted in FIG. 1 iterates until the model is considered fully evolved, based on a level of complexity threshold, and the sampling on the training dataset is stopped. After the evolution process ends, the model is then exposed to all data samples in the training dataset for training at 114.

As would be realized by one of skill in the art, the disclosed method described herein can be implemented by a system comprising a processor and memory, storing software that, when executed by the processor, performs the functions comprising the method.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A method for evolving a deep neural network model for a task, the method comprising iterating the steps of:
selecting samples of training data;
fine-tuning the model using the selected samples;
adding one or more additional convolutional layers to the model; and
pruning the model;
wherein the steps of the method are terminated when, after the fine-tuning step, the model is fully evolved and exhibits a desired level of performance.

2. The method of claim 1 wherein the initially selected samples of training data are samples which the model can easily classify.

3. The method of claim 2 wherein the initially selected samples have clustered features.

4. The method of claim 1 wherein the task is increased in difficulty with each iteration of the steps of the method.

5. The method of claim 4 wherein the complexity of the data samples selected from the training data increases with each iteration of the steps of the method.

6. The method of claim 5 wherein the difficulty of the task is increased at each iteration of the steps of the method by selecting additional samples from the training data having lower norms.

7. The method of claim 1 wherein the pruning step comprises pruning a filter when an L1 norm of its response falls below a predefined threshold.

8. The method of claim 1 further comprising:
exposing the model to all training data after the model is fully evolved.

9. The method of claim 1 wherein the desired level of performance of the model is measured by the percentage of objects in the database the model is able to correctly classify.

10. The method of claim 1 wherein the desired level of performance of the model is measured by FLOPS used by the model for each classification task.

11. A system comprising:
a processor; and
memory, storing software that, when executed by the processor, implements the steps of the method of claim 1.
